(19) United States
(12) Patent Application Publication
(10) Pub. No.: US 2005/0042440 A1
(43) Pub. Date: Feb. 24, 2005

(54) Magnesium workpiece and method for generation of an anti-corrosion coating on a magnesium workpiece

(76) Inventors: Friedrich-Wilhelm Bach, Isernhagen (DE); Tai Phan-Tan, Hannover (DE); Heinrich-Dietrich Haferkamp, Garsen (DE); Volker Kaese, Hannover (DE)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/499,993

(22) PCT Filed: Nov. 22, 2002
(86) PCT No.: PCT/DE02/04296

(30) Foreign Application Priority Data
Dec. 24, 2001 (DE) 101 63 107.3

(51) Int. Cl. B32B 15/04; B32B 31/00

(52) U.S. Cl. 428/332; 428/469; 427/372.2

(57) ABSTRACT

According to the invention, an anti-corrosion coating on a magnesium workpiece can be generated, whereby a halide salt is applied in at least one surface coat to the workpiece, with a thermodynamic stability less than a salt formed from magnesium and the same halide, such that, during the application of the halide salt to the workpiece and/or under the influence of a corrosive medium the salt with magnesium is formed.

The invention relates to a method for forming an anti-corrosion coating on a magnesium workpiece. The invention also relates to a magnesium workpiece with an anti-corrosion coating.

The importance of magnesium substances will increase hugely in the near future. This will entail increased demands for magnesium substances as construction material. An important criterion for the use of magnesium substances lies in the corrosion resistance with respect to corrosive media.

It is known to provide substances with additive systems such as polymer layers or conversion layers. The adherence and efficacy of such additional layers is dependent on geometry.

It is also known that, under the action of corrosive media, some substances can form coatings which partially prevent further penetration of the corrosive media. Oxides, for example chromium oxide, and/or metal molybdates are known as anti-corrosion coating systems for inhibiting the tendency toward pitting corrosion of stainless steels.

The invention is based on the problem of effectively increasing the corrosion resistance of magnesium workpieces in a simple manner and independently of the geometry of the workpiece.

To solve this problem, the method of the aforementioned type is characterized, according to the invention, in that a halide salt is introduced into at least one surface layer of the workpiece, which halide salt has a lower thermodynamic stability than a salt of the same halogen formed with magnesium, in such a way that, during introduction of the halide salt into the workpiece and/or under the influence of a corrosion medium, the salt with magnesium is formed.

A magnesium workpiece according to the invention which can be produced by this method according to the invention is provided with an anti-corrosion coating having a thickness of >50 μm, which contains at least a proportion of an oxygen-free halide salt, of a substituted cation of the halide salt, and of a salt with magnesium formed with the anion of the halide salt, the halide salt having a lower thermodynamic stability than the salt formed with magnesium.

According to the invention, it is thus possible to form an oxygen-free, anti-corrosion coating by introducing a suitable halide salt into the workpiece. This introduction can preferably be effected by alloying (diffusion alloying, gas alloying, melt alloying or mechanical alloying (by centrifugal casting or reaction milling), the melt alloying, for example, providing a uniform alloying through the workpiece, and diffusion alloying providing an alloying of a sufficiently deep surface layer. The alloy proportion of the halide salt in the surface layer (diffusion alloy) and in the entire workpiece (melt alloy) is at least 1 at. %, preferably around 2 at. %, but can also be as much as 15 at. %.

Fluorides are particularly preferred as halide salts. A particularly preferred halide salt is aluminum fluoride. Successful tests have also been conducted with potassium borofluoride (KBF₃) and sodium aluminum fluoride (Na₃AlF₆).

The magnesium substance can be pure magnesium, but preferably also a magnesium alloy. Particular preference is given to the use of the technical alloys AZ31, that is to say an alloy with aluminum and zinc, a magnesium alloy with lithium and calcium components, or the alloy LAE442 containing lithium, aluminum and rare earth metals (MgLi4Al4SE2 wt. %). In both cases, alloying is performed, preferably melt alloying in a crucible, with 2 at. % of a halide salt, preferably AlF₃.

### EXAMPLE 1

A pure magnesium semifinished product is to be treated with aluminum fluoride by diffusion alloying and independently of geometry. For this purpose, the magnesium semifinished product is embedded in concentrated AlF₃ (concentration>90%) in powder form and diffusion-alloyed at temperatures of up to 850° C., preferably at 420° C. in an oven for a period of the order of 24 hours. The powder packing technique is performed here in a laboratory tilting crucible oven, a CrNi steel die being used to apply to the powder surface a weight which generates a moderate pressure of 3 kPa in order to close process-related cavities in the powder packing. The relatively long dwell time of about 24 hours is intended to ensure that kinetic inhibitions, which are less noticeable at higher temperatures, are negligible. At the processing temperature, the substantial difference in the free enthalpy of reaction means that AlF₃ is converted to a substantial extent into MgF₂, so that an MgF₂ coating forms which protects against corrosion in a pH range between 3 and 14. The aluminum released in the substitution reaction as alloy component contributes to this protection.

In an immersion test in aggressive synthetic sea water, a decrease in the mass loss by corrosion to 55% at an immersion time of 96 hours was established. Under the action of sea water as corrosion medium, the rest of the coating is further strengthened since the fluoride present in the sea water with magnesium cations forms the magnesium fluoride of the stable coating.

The coatings obtained in the powder packing technique have a thickness of at least 100 μm and up to 200 μm.

The coating for pure magnesium consists of MgF₂ and AlF₃. For further alloys, coatings with the following components were established:
for MgLi 12 at. % (+AlF₃): LiF and Li3AlF₆)
for MgCa 30 wt. % (+AlF₃): MgF₂CaF₂, AlF₃.

A control of samples stored over 4 weeks shows that the coating products are stable.

### EXAMPLE 2

The magnesium substance was modified by melting in a crucible with 2 at. % AlF₃. The fluoride salt can be added to the bottom of the crucible, as a charge or by means of a cartridge, the cartridge for example consisting of magnesium or one of its alloys and finally settling into the melt to prevent combustion or evaporation.

Such modification of the technical magnesium alloy AZ31 with 2 at. % AlF₃ leads to a halving of the corrosion rate in synthetic sea water.

The magnesium alloys can also contain varying Li proportions and Ca proportions, the Li proportion being between 0 and 30 at. % and the Ca proportion being between 0 and 5 wt. %.

The modification with the halide salt, here the fluoride, can lie between 1 and 15 at. %.

### EXAMPLE 3

The alloy LAE442 (MgLi4Al4SE2 wt. %) was alloyed with 2 at. % AlF₃ in a crucible. This alloy has a 10-fold better corrosion resistance in aggressive electrolytes (tested with synthetic sea water or with 5% NaCl solution). The alloy has satisfactory mechanical characteristics even in the cast state, namely
R_{p0.2}=80 MPa
Rₘ=180 MPa
A₅=8%

1. A method for forming an anti-corrosion coating on a magnesium workpiece, characterized in that a halide salt is introduced into at least one surface layer of the workpiece, which halide salt has a lower thermodynamic stability than a salt of the same halogen formed with magnesium, in such a way that, during introduction of the halide salt into the workpiece and/or under the influence of a corrosion medium, the salt with magnesium is formed.

2. The method as claimed in claim 1, characterized in that the introduction of the halide salt into the surface layer is effected by diffusion alloying, gas alloying, melt alloying, mechanical alloying, centrifugal casting or reaction milling.

3. The method as claimed in claim 2, characterized in that the halide salt is introduced into the surface layer by embedding the workpiece in the pulverulent halide salt and by diffusion alloying at temperatures of between 300 and 650° C.

4. The method as claimed in claim 1, characterized in that the coating formation is strengthened or enriched by means of sea water as corrosion medium.

5. The method as claimed in claim 1, characterized in that the workpiece contains additions of lithium and/or calcium.

6. The method as claimed in claim 1, characterized in that a fluoride is introduced as the halide salt.

7. The method as claimed in claim 6, characterized by using AIF₃ as the halide salt.

8. The method as claimed in claim 6, characterized by using KBF₄ and/or Na₃AlF₆ as the halide salt.

9. The method as claimed in claim 1, characterized in that the halide salt is introduced into the workpiece with a concentration of at least 1 at. %.

10. The method as claimed in claim 9, characterized in that the halide salt is introduced into the workpiece with a concentration of between 1.5 and 2.5 at. %.

11. A magnesium workpiece with an anti-corrosion coating having a thickness of >50 μm, which contains at least a proportion of an oxygen-free halide salt, of a substituted cation of the halide salt, and of a salt with magnesium formed with the anion of the halide salt, the halide salt having a lower thermodynamic stability than the salt formed with magnesium.

12. The workpiece as claimed in claim 11, characterized in that the halide salt is a fluoride.

13. The workpiece as claimed in claim 12, characterized in that the halide salt is AlF₃.

14. The workpiece as claimed in claim 12, characterized in that the halide salt is KBF₃ or Na₃AlF₆.

15. The workpiece as claimed in one of claims 11 through claim 13, characterized in that the rest of the magnesium workpiece consists of pure magnesium.

16. The workpiece as claimed in claim 11, characterized in that the rest of the magnesium workpiece consists of a magnesium alloy.

17. The workpiece as claimed in claim 16, characterized in that the magnesium alloy contains Li and/or Ca.

18. The workpiece as claimed in claim 17, characterized in that the magnesium alloy contains Li proportions of up to 30 at. % and Ca proportions of up to 5 wt. %.

19. The workpiece as claimed in claim 11, characterized in that the halide salt proportion is at least 1 at. %.

20. The workpiece as claimed in claim 19, characterized in that the halide salt proportion is up to 15 at. %.

21. The workpiece as claimed in claim 11, characterized by a concentration of the halide salt of between 1.5 and 2.5 at. % in the area of the magnesium workpiece into which the halide salt has been introduced.
